(19) United States
(12) Patent Application Publication
(10) Pub. No.: US 2025/0095129 A1
(43) Pub. Date: Mar. 20, 2025

(54) METHOD AND DEVICE FOR AUTOMATIC OPTICAL INSPECTION

(71) Applicant: Robert Bosch GmbH, Stuttgart (DE)

(72) Inventors: Jiabo He, Shanghai (CN); Yige Li, Shanghai (CN)

(21) Appl. No.: 18/826,744

(22) Filed: Sep. 6, 2024

(30) Foreign Application Priority Data
Sep. 18, 2023 (CN) 2023 1120 3817.4

(51) Int. Cl. G06T 7/00; G06V 10/26; G06V 10/74; G06V 10/764; G06V 10/77; G06V 10/774; G06V 10/776; G06V 10/82

(52) U.S. Cl. CPC G06T 7/0004; G06V 10/26; G06V 10/761; G06V 10/764; G06V 10/7715; G06V 10/774; G06V 10/776; G06V 10/82; G06T 2207/20081

(57) ABSTRACT

A method for automatic optical inspection (AOI) includes (i) obtaining an image of an inspected component of a first domain, (ii) inputting the image of the inspected component into an inspection model, the inspection model comprising a generic feature extraction sub-model and at least one task inspection sub-model associated with a particular AOI task of the first domain, (iii) generating, by the generic feature extraction sub-model, a first feature representation of the image based on the image of the inspected component, and (iv) generating, by the at least one task inspection sub-model, at least one inspection result associated with the particular AOI task of the first domain based on the first feature representation of the image.

This application claims priority under 35 U.S.C. § 119 to patent application no. CN 2023 1120 3817.4, filed on Sep. 18, 2023 in China, the disclosure of which is incorporated herein by reference in its entirety.

The present application relates to optical inspection, and more particularly relates to a method and device for automatic optical inspection (AOI) based on a visual base model.

### BACKGROUND

During the manufacturing of industrial products such as machinery or electronic products, pits, wear, scratches, and other defects may occur due to defects in machining technology, incomplete manufacturing conditions, accidental mechanical failures and other factors. These defects increase manufacturing costs, shorten the service life of manufactured products, and even cause substantial harms to users. For example, defects of automotive critical machinery or electronic components may be potential security issues. Therefore, the inspection of product defects is a key effort to improve the product quality.

The automatic defect inspection technology has a distinct advantage over manual inspection, which can not only reduce the workload of inspection personnel, but also can improve the efficiency, stability, and performance of the inspection process while adapting to a variety of work environments that are not suitable for humans. AOI systems based on deep learning may implement efficient and stable automatic inspection of industrial components.

In existing AOI systems based on deep learning, a specific AOI inspection model based on deep learning requires to be trained for an industrial component of one domain (e.g., one industrial component type, or one industrial component production line), and in order to train the inspection model to perform an AOI inspection task, a large number of component images of this domain require to be collected and labeled as training data. However, particularly for large enterprises with a wide variety of industrial component production lines, the AOI task of each industrial component requires to collect and label a large amount of image data of industrial components in this type. Moreover, for a new industrial component, such as a newly established industrial component production line, it takes a long time to collect a large number of defective component images, which will require more time for labeling correspondingly. Moreover, training one specific AOI inspection model based on deep learning for each domain also means substantial computational resources and time costs in terms of model training itself. Based at least on the above issues, there is a need to further improve the development, maintenance and upgrade efficiency of the AOI system based on deep learning for AOI inspection with many types of industrial components.

### SUMMARY

The following introduction is provided in order to introduce selected concepts in a simple manner, and these concepts will be further described in the detailed description below. The introduction is not intended to highlight the key or necessary features of the claimed subject matter, nor is it intended to limit the scope of the claimed subject matter.

In response to the above problems, the present application provides a method, device and system of AOI inspection based on a visual base model and a lightweight AOI task inspection model. The above-mentioned problem of efficiency of AOI inspection for many types of industrial components is effectively solved through inter-domain adaptive capabilities implemented by the visual base model and the lightweight AOI task inspection model.

According to one aspect of the present application, a method for AOI is provided, which comprises: obtaining an image of an inspected component of a first domain, the first domain corresponding to a first industrial component type or corresponding to a first industrial component production line; inputting the image of the inspected component into an inspection model, the inspection model comprising a generic feature extraction sub-model and at least one task inspection sub-model associated with a particular AOI task of the first domain; generating, by the generic feature extraction sub-model, a first feature representation of the image based on the image of the inspected component; generating, by the at least one task inspection sub-model, at least one inspection result associated with the particular AOI task of the first domain based on the first feature representation of the image.

According to one aspect of the present application, a method of training an inspection model for AOI is provided, which comprises: collecting images of industrial components in a plurality of domains as a multi-domain AOI training dataset, wherein the plurality of domains correspond to a plurality of industrial component types, respectively or correspond to a plurality of industrial component production lines, respectively; training the generic feature extraction sub-model in the inspection model based on the multi-domain AOI training dataset to obtain a trained generic feature extraction sub-model; training at least one task inspection sub-model associated with a particular AOI task of a first domain based on an image of an industrial component in the first domain as a single-domain AOI training dataset, the first domain corresponding to a first industrial component type or corresponding to a first industrial component production line, wherein the trained generic feature extraction sub-model receives an image in the single-domain AOI training dataset and outputs a first feature representation of the image, and the at least one task inspection sub-model receives the first feature representation of the image and predicts at least one inspection result associated with the particular AOI task of the first domain.

According to one aspect of the present application, a device for AOI is provided, which comprises: an image obtaining module for obtaining an image of an inspected component of a first domain, the first domain corresponding to a first industrial component type or corresponding to a first industrial component production line; an inspection module, the inspection module comprising a generic feature extraction sub-module and at least one task inspection sub-module associated with a particular AOI task of the first domain, the generic feature extraction sub-module generating a first feature representation of the image based on the image of the inspected component, and the at least one task inspection sub-module generating at least one inspection result associated with the particular AOI task of the first domain based on the first feature representation of the image.

According to one aspect of the present application, a system for AOI is provided, which comprises: an image capture apparatus for capturing an image of an inspected component; one or more processors; and one or more memories, the memories having computer-executable instructions stored thereon, and the instructions, when run by the one or more processors, perform operations according to the examples of the present application.

According to one aspect of the present application, a computer system for AOI is provided, which comprises: one or more processors; and one or more memories, the memories having computer-executable instructions stored thereon, and the instructions, when run by the one or more processors, perform operations according to the examples of the present application.

According one aspect of the present disclosure, a machine-readable storage medium is provided, executable instructions are stored on the machine-readable storage medium, and the instructions, when executed, cause one or more processors to perform operations according to the examples of the present application.

By using the technical solution of the present application, a universal visual representation (UVR) adapted to a plurality of domains of industrial component images is capable of being extracted by a visual base model trained based on the industrial component images of the plurality of domains as an unlabeled dataset, the UVR of the images serves as an integrated rich feature representation and is capable of adapting to the plurality of domains corresponding to the training dataset and a plurality of unknown domains rather than the training dataset. Therefore, when combined with a lightweight task inspection head of an AOI inspection system, the task inspection head can be trained based on a small amount of domain-specific training data with a label, thereby greatly improving the generalization and learning efficiency of the AOI inspection system for new tasks. Moreover, by integrating the visual base model and a plurality of task inspection heads dedicated to the plurality of domains individually, the visual base model that has been pre-trained through a large number of industrial component images of the plurality of domains can be efficiently utilized, unlike prior art which requires training a specific AOI inspection model based on deep learning for each domain. Moreover, inspection can be performed by integrating the visual base model and the plurality of task inspection heads dedicated to a plurality of domains individually, and AOI inspection processing of a plurality of production lines can be processed in an assembly line manner by the integrated AOI inspection model, thereby further improving the utilization rate of computing resources.

### BRIEF DESCRIPTION OF THE DRAWINGS

The nature and advantages of the content of the present application may be further implemented by referring to the following accompanying drawings. In the accompanying drawings, similar assemblies or features may have the same reference numerals.

FIG. 1 shows a block diagram of an AOI system according to one example.

FIG. 2A to FIG. 2D show block diagrams of an AOI device for an industrial component, respectively according to one example.

FIG. 3 shows a block diagram of an AOI device for an industrial component according to one example.

FIG. 4 shows a block diagram of an AOI device for an industrial component according to one example.

FIG. 5 shows a block diagram of an AOI system for an industrial component according to one example.

FIG. 6 shows a schematic diagram of a comparative learning method for training a visual base model according to one example.

FIG. 7 shows a schematic diagram of a MAE learning method for training a visual base model according to one example.

FIG. 8 shows a schematic diagram of an inspection model for training tasks according to one example.

FIG. 9 shows a flow chart of a method for performing AOI according to one example.

FIG. 10 shows a flow chart of a method of training an inspection model for AOI according to one example.

FIG. 11 shows a block diagram of a device for AOI of an industrial component according to one example.

FIG. 12 shows a block diagram of a processing system of AOI for an industrial component according to one example.

### DETAILED DESCRIPTION

The subject matter described herein will now be discussed with reference to exemplary embodiments. It should be understood that discussions about these embodiments are provided to aid those skilled in the art in better understanding and thereby implementing the subject matter described herein rather than limiting the scope of protection, applicability, or examples described in the claims. Changes may be made to the functions and arrangements of the elements discussed without departing from the scope of protection of the content of the present application. Various processes or assemblies may be omitted, substituted, or added in the various examples as needed. For example, the described methods may be performed in a different order than that described, and various steps may be added, omitted, or combined. In addition, features described in relation to some examples may also be combined in other examples.

As used herein, the term “comprise” and its variations are open terms, with the meaning of “comprise, but not are limited to.” The term “based on” indicates “at least partially based on”. The term “one example” and “an example” indicate “at least one example”. The term “another example” indicates “at least one other example.” The terms “first”, “second”, etc. may refer to different or same objects. Other definitions, whether explicit or implied, may be included below. Unless explicitly stated in the context, the definition of one term is consistent throughout the specification.

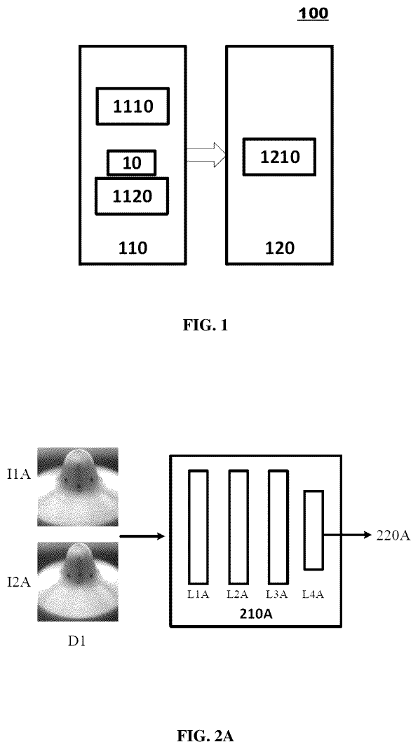

FIG. 1 shows a block diagram of an AOI system according to one example.

The AOI system 100 may be a device for inspecting finished or semi-finished products of industrial components produced. For example, the AOI system 100 may be deployed on a production line to inspect components during the manufacturing. The AOI system 100 may be a part of the production line or may be deployed in a location separate from the production line.

The AOI system 100 may comprise a front end 110, and the front end 110 may also be referred to as an optical system or a vision system 110. The front end 110 comprises an imaging unit 1110 and an object carrier unit 1120. The imaging unit 1110 may capture an image of an object 10 placed on the carrier unit 1120. In one example, the imaging unit 1110 may comprise a sensing element and an optical focusing system that cooperate to implement imaging of the object 10.

An example of the carrier unit 1120 may be a mechanical platform, a robot arm, a conveyor belt, etc., which may grab, hold, and convey the object 10, so that the imaging unit 1110 shoots the image of the object 10. In one example, the imaging unit 1110 and the carrier unit 1120 may cooperate to shoot a plurality of images of different parts of the object 10.

Although the carrier unit 1120 is shown as a part of the front end 110, it should be understood that in some implementations, the front end 110 may not actually comprise the carrier unit 1120, rather, the carrier unit is a part of a production line. For example, the object 10 may be a semi-finished component placed on the carrier unit 1120 along the production line, and the imaging unit 1110 is deployed at this part of the production line for inspection of the semi-finished components during the manufacturing.

The front end 110 may send the image of the object 10 to the rear end 120, and the rear end 120 may also be referred to as a processing system or computing system 120. The processing system 120 may be implemented in a variety of ways, for example, the processing system 120 may comprise one or more processors and/or controllers and one or more memories, and the processors and/or controllers may execute software to perform various operations or functions, such as operations or functions according to various aspects of the present application.

The processing system 120 may receive image data from the imaging unit 1110 and perform various operations by analyzing the image data. In the example of FIG. 1, the processing system 120 may comprise an AOI inspection module 1210, and the AOI inspection module 1210 may perform AOI inspection processing on the image of the received object 10. For example, the AOI inspection module 1210 may perform classification processing on the image of the object 10, for example, a classification result may indicate whether the object 10 is a qualified product. For another example, the AOI inspection module 1210 may segment the image of the object 10 to output a mask and class indicative of a defective part in the image. For another example, the AOI inspection module 1210 may perform identification processing on the image of the object 10 to output a boundary frame and class indicative of a defective part in the image. It will be understood that the AOI inspection module 1210 may perform one or more of the tasks described above and that performing the inspection task through the AOI inspection module 1210 is capable of predicting whether the object 10 as a product is a defective product and/or what kind of defect the object has.

It will be understood that the AOI inspection module 1210 may be implemented in a variety of ways, e.g., may be implemented as a software module or function. It will be understood that the computing system 120 may further comprise other modules in addition to the module 1210. For example, a control module in the computing system 120 may be configured to control operations of the imaging unit 1110 and the carrier unit 1120 in order to shoot one or more images of the object 10, for example, the imaging unit 1110 and the carrier unit 1120 may cooperate under the control of the control module to shoot a plurality of images of different parts of the object. It will be understood that the control module may also be implemented in the front end 110. It will be understood that the computing system 120 may be co-located with the front end 110 in the AOI system 100, for example, in a housing of the AOI system 100, and may also be located at a position away from the front end 110, e.g., the computing system 120 may be implemented on a server or cloud, and images shot by the front end 110 may be transmitted via wired or wireless communication connections to the computing system 120.

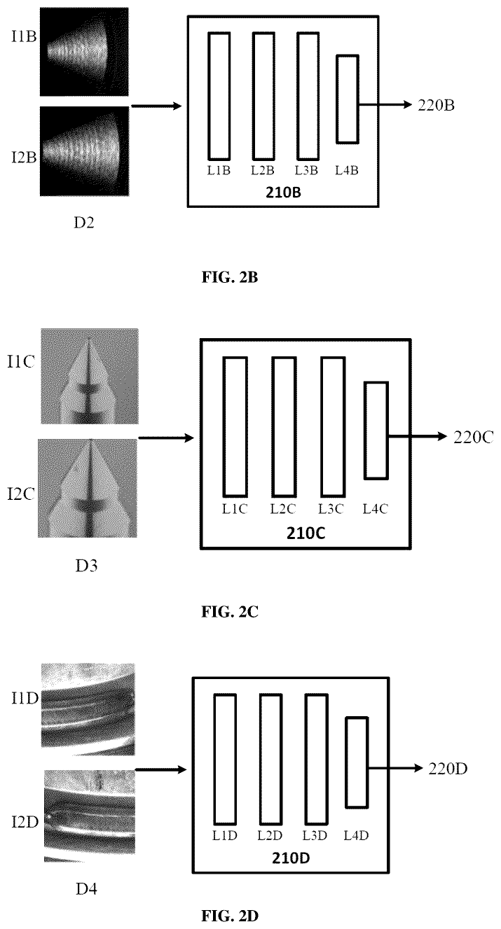

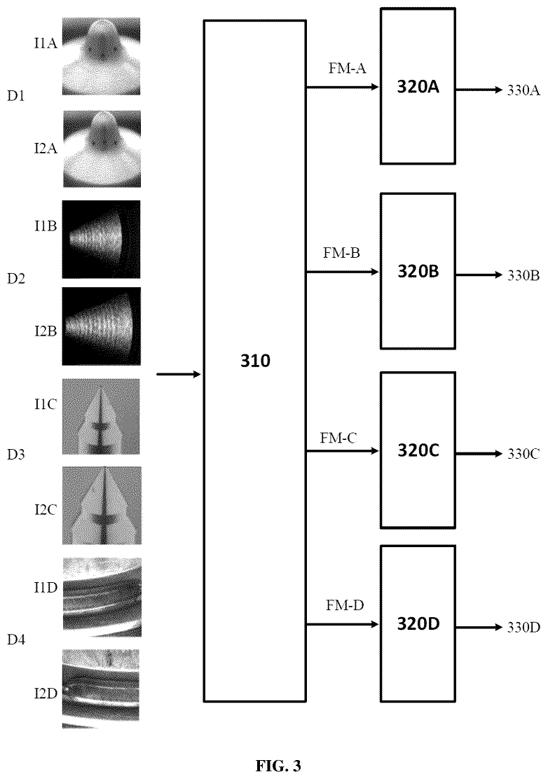

FIG. 2A to FIG. 2D show block diagrams of an AOI device for an industrial component, respectively according to one example.

As shown in FIG. 2A, images I1A and I2A may be images of industrial components 10 on a first production line. Since the industrial components of the first production line are of the same type, the images of these industrial components belong to the same domain D1. As used herein, the term “domain” corresponds to an industrial component type or an industrial component production line. Upon the receipt of images of the industrial components 10 from the imaging unit 1110 (e.g., images I1A, I2A), the AOI inspection module 210A specific to the domain D1 may process the images I1A and I2A to extract feature representations of the images and predict outputs 220A associated with AOI tasks, for example, a classification result, a segmentation result, and/or an identification result regarding the images. Those skilled in the art will appreciate that any suitable neural network model can be employed to implement the above-described classification task, segmentation task, and identification task.

Similarly, in the implementation of FIG. 2B to FIG. 2D, the images I1B and I2B may be images of industrial components 10 on a second production line, which belong to a domain D2, the images I1C and I2C may be images of industrial components 10 on a third production line, which belong to a domain D3, and the images I1D and I2D may be images of industrial components 10 on a fourth production line, which belongs to a domain D4. The AOI inspection module 210B specific to the domain D2 may process the images I1B and I2B to extract feature representations of the images and predict outputs 220B associated with AOI tasks, the AOI inspection module 210C specific to the domain D3 may process images I1C and I2C to extract feature representations of the images and predict outputs 220C associated with AOI tasks, and the AOI inspection module 210D specific to the domain D4 may process images I1D and I2D to extract feature representations of the images and predict outputs 220D associated with AOI tasks.

Each of the AOI inspection modules 210A to 210D is a specific implementation of the AOI inspection module 1210. Because the AOI inspection modules 210A to 210D are domain-specific AOI inspection modules, there is a need to collect and label a large amount of training image data in respective domains in a training phase of the AOI inspection modules 210A to 210D. Specifically, a large amount of training image data is collected and labeled in the domain D1 to train the AOI inspection module 210A, a large amount of training image data is collected and labeled in the domain D2 to train the AOI inspection module 210B, and the like.

FIG. 3 shows a block diagram of an AOI device for an industrial component according to one example.

As shown in FIG. 3, the images I1A, I2A to I1D, 12D may be industrial component images corresponding to a plurality of domains D1 to D4 shown in FIG. 2A to FIG. 2D. As noted above, images I1A, I2A to I1D, I2D are, for example, images of industrial components from four different production lines, respectively. The AOI inspection module comprising a visual base model 310 and task inspection models 320A to 320D may be a particular implementation of the AOI inspection module 1210 shown in FIG. 1.

The visual base model 310 may be a self-attention mechanism model, e.g., the visual base model 310 may employ a stratified visual transformer (e.g., Swin, CvTVision, CSwin, SAM, DINOv2, etc.) to extract feature representations of the images as a stem encoder. By pre-training the visual base model 310 based on an unlabeled dataset of industrial component images of the plurality of domains, the trained visual base model 310 is capable of extracting a universal visual representation (UVR) adapted to the plurality of domains of the industrial component images, the UVR of the images is capable of adapting to the plurality of domains corresponding to the training dataset and a plurality of unknown domains rather than the training dataset, thus the AOI inspection module 1210 comprising the visual base model 310 is capable of learning the generic AOI capability across the plurality of domains.

The task inspection models 320A to 320D are task inspection models that are specific to domains D1 to D4, respectively. The task inspection models 320A to 320D are lightweight task inspection models compared to the task inspection models 210A to 210D specific to domains D1 to D4 shown in FIG. 2A to FIG. 2D. Taking the task inspection model 320A as an example, after the visual base model 310 receives the image I1A and generates a feature representation FM-A of the image I1A, the task inspection model 320A executes an AOI inspection task based on the feature representation FM-A and outputs an inspection result 330A. For example, the AOI inspection task may be one or more of a classification task, a segmentation task, and an identification task, and the respective inspection result 330A may be one or more of a classification result, a segmentation result, and an identification result. Similarly, after the visual base model 310 receives the image I1B and generates the feature representation FM-B of the image 11B, the task inspection model 320B executes an AOI inspection task based on the feature representation FM-B and outputs an inspection result 330B, and the task inspection models 320C and 320D also execute AOI inspection tasks based on the feature representations FM-C and FM-D of the images I1C and I1D generated by the visual base model 310, respectively.

Since the pre-trained visual base model 310 has performed a universal feature extraction across the plurality of domains on the component images, the task inspection models 320A to 320D need to only be implemented employing lightweight task models. Accordingly, the task inspection models 320A to 320D need to be trained based on only a small amount of domain-specific training data with a label compared to the training of the task inspection models 210A to 210D shown in FIG. 2A to FIG. 2D, thereby greatly improving the learning efficiency of the AOI inspection system for new tasks. Moreover, by integrating the visual base model and a plurality of task inspection heads dedicated to the plurality of domains individually, the visual base model that has been pre-trained through a large number of industrial component images of the plurality of domains can be efficiently utilized, unlike prior art which requires training a specific AOI inspection model based on deep learning for each domain.

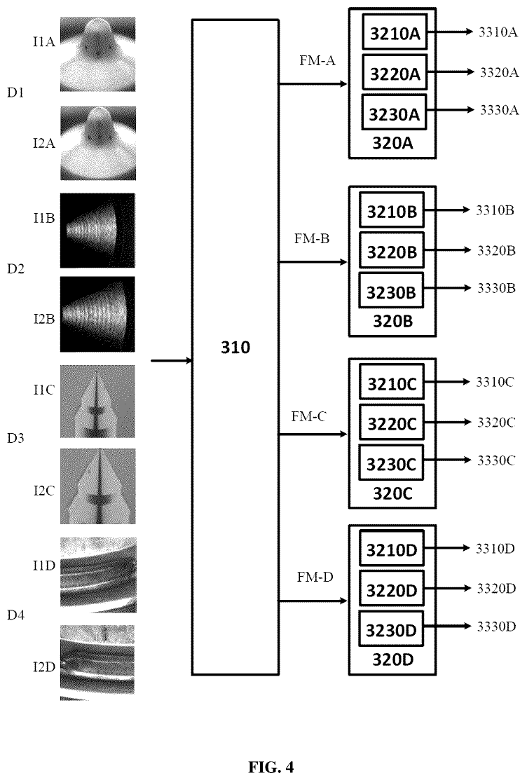

FIG. 4 shows a block diagram of an AOI device for an industrial component according to one example.

The same reference numbers in FIG. 4 as shown in FIG. 3 indicate the same units, and the corresponding parts are no longer described in detail. As shown in FIG. 4, the task inspection models 320A to 320D comprise classification models 3210A to 3210D, segmentation models 3220A to 3220D, and identification models 3230A to 3230D, respectively. Taking the task inspection model 320A as an example, after the visual base model 310 receives the image I1A and generates the feature representation FM-A of the image I1A, the classification model 3210A in the task inspection model 320A performs a classification task based on the feature representation FM-A and outputs a classification result 3310A, the segmentation model 3220A performs a segmentation task based on the feature representation FM-A and outputs a segmentation result 3320A, and the identification model 3230A performs an identification task based on the feature representation FM-A and outputs an identification result 3330A. Similarly, after the visual base model 310 receives the image I1B and generates a feature representation FM-B of the image I1B, the classification model 3210B, the segmentation model 3220B, and the identification model 3230B in the task inspection model 320B perform a classification task, a segmentation task, and an identification task based on the feature representation FM-B, respectively, for determining whether a component corresponding to the image is an unqualified component. The classification models 3210C and 3210D, the segmentation models 3220C and 3220D, and the identification models 3230C and 3230D in the task inspection models 320C and 320D also perform respective classification tasks, segmentation tasks, and identification tasks based on the feature representations FM-C and FM-D of the images I1C and I1D generated by the visual base model 310, respectively, for determining whether the components corresponding to the images are unqualified components. It will be understood by those skilled in the art that, although in the example shown in FIG. 4, the task inspection models 320A to 320D each comprises a classification model, a segmentation model, and an identification model, in other examples, one or more of the task inspection models 320A to 320D may not need to comprise all of the classification model, the segmentation model, and the identification model, but only comprise one or more of the classification model, the segmentation model, and the identification model, and can also comprise other models rather than the classification model, the segmentation model, and the identification model. It will be understood by those skilled in the art that, although in the examples shown in FIG. 3 and FIG. 4, the AOI inspection module 1210 comprises a visual base model 310 and a plurality of domain-specific task inspection models 320, in other examples, the AOI inspection module 1210 may comprise a visual base model 310 and one domain-specific task inspection model 320.

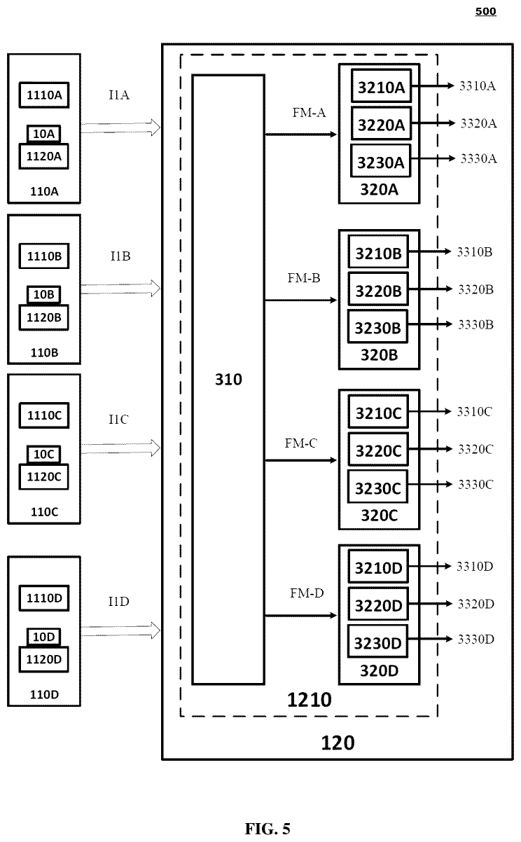

FIG. 5 shows a block diagram of an AOI system for an industrial component according to one example.

The reference numerals in FIG. 5 that are the same or similar to those shown in FIG. 1, FIG. 3, FIG. 4 represent the same or similar units, with the corresponding portions not described in detail. As shown in FIG. 5, each of the plurality of front ends 110A to 110D has a similar structure as the front end 110 shown in FIG. 1, for example, the front ends 110A to 110D are arranged separately in a plurality of different production lines, images of industrial components on respective production lines are shot using imaging apparatuses 1110A to 1110D, such as images I1A to I2D shown in FIG. 3 and FIG. 4, and the shoot images are provided to the processing system 120. The AOI inspection module 1210 on the processing system 120 comprises the visual base model 310 and task inspection models 320A to 320D described above in connection with FIG. 3 and FIG. 4. The visual base model 310 processes images I1A to I1D of the plurality of domains from the front ends 110A to 110D to obtain feature representations FM-A to FM-D of the images, and inputs the feature representations FM-A to FM-D into the task inspection models 320A to 320D, respectively, and the inspection results 3310A to 3330A, 3310B to 3330 B, 3310C to 3330C, 3310D to 3330D are obtained by the task inspection models 320A to 320D based on the feature representations FM-A to FM-D, respectively. In the example of the AOI system shown in FIG. 5, AOI inspection tasks for a plurality of production lines are performed by integrating the visual base model and a plurality of task inspection heads dedicated to a plurality of domains, the AOI inspection processing of a plurality of production lines can be processed in an assembly line manner through the integrated AOI inspection model, thereby potentially further improving the utilization rate of computing resources of the computing device 120.

It will be understood by those skilled in the art that, although in the example shown in FIG. 5, the AOI inspection module 1210 comprises a visual base model 310 and a plurality of domain-specific task inspection models 320A to 320D, in other examples, the AOI inspection module 1210 may also comprise a visual base model 310 and one task inspection model 320, for processing AOI inspection from an industrial component of one domain (e.g., one production line).

FIG. 6 shows a schematic diagram of a comparative learning method for training a visual base model according to one example.

To train the visual base model 310, it is desirable to establish a large-scale dataset comprising industrial component images of a plurality of domains. Referring to the example of the AOI system 500 shown in FIG. 5, for large enterprises with a wide variety of industrial component production lines, images of various types of industrial components can be obtained by imaging units 1110 deployed on various production lines as a training dataset for pre-training the visual base model. For example, in one example, the industrial component images in millions of units may be collected from a plurality of production lines as an AOI training dataset for pre-training the visual base model.

In one example, the comparative learning method shown in FIG. 6 may be employed to train the visual base model 310 to learn to extract feature representations of industrial component images of the plurality of domains. Taking the industrial component image I1 shown in FIG. 6 as an example, a data enhancement module 610 performs enhancement processing on the image I1 to obtain an image pair (I1-1, I1-2). For example, the data enhancement module 610 may obtain the image pair (I1-1, I1-2) by processing the image I1 through color changes, brightness changes, random shearing, flipping, rotation, etc., and the image pair may be referred to as a positive pair.

The visual base model 310 performs encoding processing on images I1-1 and I1-2 to obtain feature representations FM-1 and FM-2 of the respective images, respectively. The comparison module 620 obtains a similarity between the two images I1-1 and I1-2 based on the feature representations FM-1 and FM-2, for example, the similarity may be a sinusoidal similarity between respective feature vectors of the two images I1-1 and I1-2. In one example, the comparison module 620 may calculate the sinusoidal similarity between the feature representations FM-1 and FM-2 as the similarity S1 between the two images I1-1 and I1-2. In another example, the comparison module 620 may further comprise an additional neural network layer for transforming FM-1 and FM-2 to feature representations FM-1Z and FM-2Z in another space, and the comparison module 620 calculates the sinusoidal similarity between the feature representations FM-1Z and FM-2Z as the similarity S1 between the two images I1-1 and I1-2.

A loss determination module 630 may determine a loss value L1 based on the similarity S1 between the two images I1-1 and I1-2. For example, the loss value L1 may be determined based on the similarity of the positive pair (I1-1, I1-2) and the similarity of a negative pair formed by an enhanced image and one batch of other images. Determining the loss value based on the similarity of the positive pair and the negative pair is a commonly used technical means in the field of image processing and is therefore no longer detailed. The visual base model 310 may then be updated based on a comparative learning loss value L1, for example, a known AdamW optimizer may be employed to update the visual base model 310 based on the loss L1.

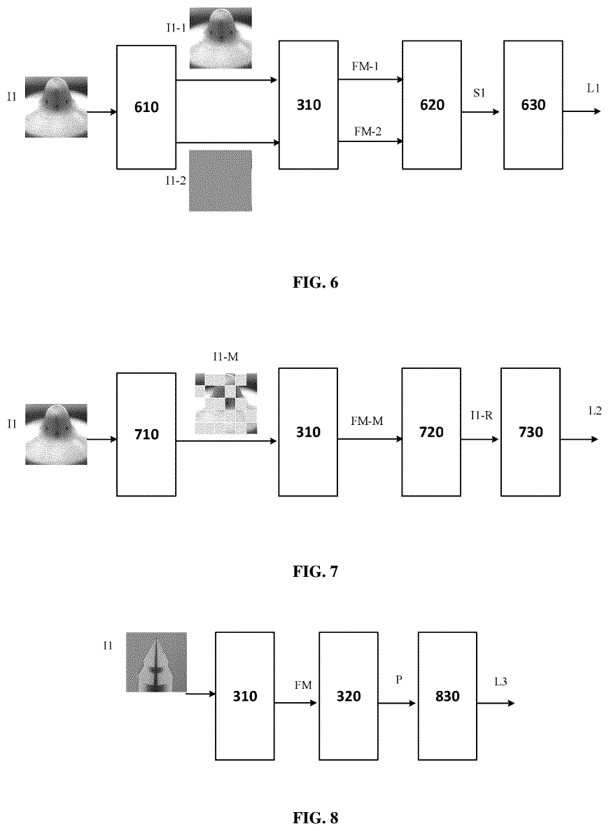

FIG. 7 shows a schematic diagram of a masked autoencoder (MAE) learning method for training a visual base model according to one example.

In one example, the MAE method shown in FIG. 7 can be employed to train the visual base model 310 to learn to extract feature representations of industrial component images of a plurality of domains. Using the industrial component image I1 shown in FIG. 7 as an example, a masking module 710 performs mask processing on the image I1 to obtain a masked image I1-M. For example, the masking module 710 segment the image I1 into small blocks, parts of the small blocks are randomly selected to be reserved, and the remaining small blocks are all masked to obtain a masked image I1-M.

The visual base model 310 performs encoding processing on the masked image I1-M to obtain a feature representation FM-M of the masked image. A decoder 720 decodes the restored image I1-R based on the feature representation FM-M. A loss determination module 730 determines an MAE loss value L2 based on the restored image I1-R and the original image I1. For example, the loss determination module 730 may employ a mean squared error (MSE) function as a loss function to determine an MAE loss value L2, that is, an original pixel in the original image I1 subtracts a reconstituted pixel in the restored image I1-R, followed by solving a sum of squares. The visual base model 310 may then be updated based on the MAE loss value L2, for example, a known AdamW optimizer may be employed to update the visual base model 310 based on the loss L2.

In one example, the comparative learning method and the MAE method shown in FIG. 6 and FIG. 7 may be employed simultaneously to train the visual base model 310, e.g., the weighting of the loss values L1 and L2 may be used as a loss value to update the visual base model.

It will be understood by those skilled in the art that any appropriate training method can be employed to train the visual base model 310. The visual base model 310, trained by the large-scale dataset comprising industrial component images of a plurality of domains, learns both the domain-specific feature representations and the generic feature representations covering individual domains, so the feature representations of the industrial component image extracted with the visual base model 310 as a feature extractor are capable of assisting the various downstream domain-specific AOI inspection modules 320 in learning AOI inspection tasks adapted to the respective domains through a lightweight domain-specific adaptive training process.

FIG. 8 shows a schematic diagram of an inspection model 320 for training tasks according to one example.

Taking the task inspection model 320C specific to the domain D3 shown in FIG. 3 and FIG. 4 as an example, the task inspection model 320 may comprise one or more of a classification model 3210, a segmentation model 3220, and an identification model 3230. In one example, the classification model 3210 may be a multi-layer perceivorator (MLP) model, the segmentation model 3220 may be a mask decoder of a convolutional neural network (CNN) model or a decoder based on an attention mechanism, and the identification model 3230 may be a boundary frame decoder with a classification result of the CNN model or a decoder based on the attention mechanism. The task inspection model 320, more specifically the classification model 3210, the segmentation model 3220, and/or the identification model 3230 therein, may be trained based on the image set collected and labeled in the domain D3 as a training dataset. In one example, the lightweight task heads 3210, 3220, and 3230 may be trained based on a small number of training datasets specific to the domain D3, for example, the small number of training datasets may be datasets in hundreds of images as a unit.

The visual base model 310 performs encoding processing on the image I1 to obtain a feature representation FM of the image. The task inspection model 320 obtains a prediction P for the inspection task based on the feature representation, for example, the classification model 3210, the segmentation model 3220, and/or the identification model 3230 obtain predictions P1, P2, and/or P3 for the inspection task based on the feature representation, respectively. The loss determination module 830 determines a loss value L3 based on predicted results P1, P2, and/or P3 and respective labels representing the labeled inspection results, specifically comprising loss values L3-1, L3-2, and/or L3-3 corresponding to the predicted results P1, P2, and/or P3, respectively. Various appropriate methods for determining a supervised loss using predicted values and label values may be employed to determine the loss value L3. The task inspection model 320 may then be updated based on the supervised loss value L3 and, in particular, the classification model 3210, the segmentation model 3220, and/or the identification model 3230 are updated based on the loss values L3-1, L3-2, and/or L3-3, for example, a known AdamW optimizer may be employed to update the task inspection model 320 based on the loss L3. In one example, parameters of the pre-trained visual base model 310 are frozen in the process of updating the task inspection model 320. In another example, a small part of the parameters of the pre-trained visual base model 310 may be updated simultaneously in the process of updating the task inspection model 320.

In the example shown in FIG. 8, the task inspection model 320 may be trained using an industrial component image of a domain other than industrial component images of the plurality of domains for training the visual base model 310. For ease of illustration, a plurality of domains for training the visual base model 310 are represented with the domains D1 to D4 shown in FIG. 3, the domain for training the task inspection model 320 is represented with the domain D5, and those skilled in the art are capable of appreciating that more domains are actually used to train the visual base model 310. The visual base model 310, trained by the large-scale dataset comprising a plurality of industrial component images of the domains D1 to D4, learns not only generic feature representations specific to the domains and covering various domains, but also the generic feature representations can be transferred to a domain not seen by the visual base model 310. Therefore, in this example, the task inspection model 320 corresponding to the domain D5 not seen by the visual base model 310 may be trained. The example is particularly advantageous in executing AOI of the components produced in the early stage of the establishment of a new production line corresponding to the domain D5, for example.

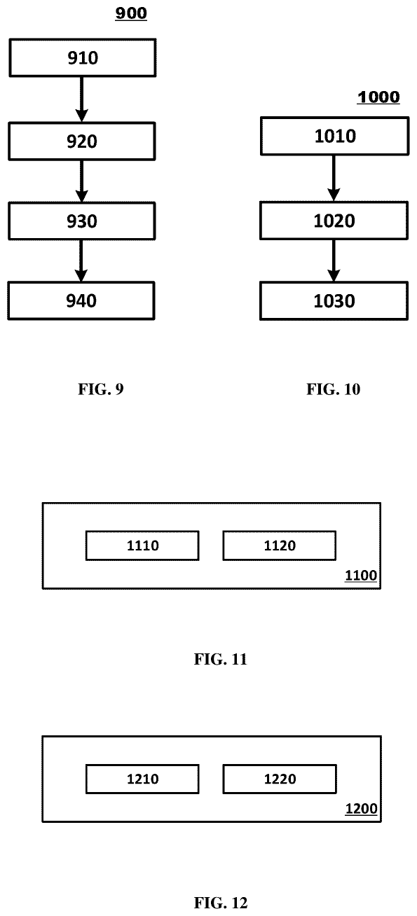

FIG. 9 shows a flow chart of a method for performing AOI according to one example.

At step 910, an image of the inspected component of the first domain is obtained, and the first domain corresponds to a first industrial component type or corresponds to a first industrial component production line.

At step 920, the image of the inspected component is input into an inspection model, and the inspection model comprises a generic feature extraction sub-model and at least one task inspection sub-model associated with a particular AOI task of the first domain.

At step 930, a first feature representation of the image is generated by the generic feature extraction sub-model based on the image of the inspected component.

At step 940, at least one inspection result associated with the particular AOI task of the first domain is generated by the at least one task inspection sub-model based on the first feature representation of the image.

In one example, the particular AOI task of the first domain comprises at least one or at least two of the following tasks: a classification task for classifying the image of the inspected component into one class in a plurality of classes, e.g., the plurality of classes comprise normal, defective, or others; a segmentation task for segmenting a defective area in the image of the inspected component, e.g., a segmented target area is represented by a mask, wherein a pixel value of the target area is 1, and pixel values of the remaining areas are 0; and an identification task for identifying the defective area in the image of the inspected component, e.g. the identified area is represented by a boundary frame.

In one example, when the particular AOI task of the first domain is the classification task, the task inspection sub-model is an MLP model; when the particular AOI task of the first domain is the segmentation task, the task inspection sub-model is a mask decoder of the CNN model or a decoder based on the attention mechanism; and when the particular AOI task of the first domain is an identification task, the task inspection sub-model is a boundary frame decoder with the classification result of the CNN model or a decoder based on the attention mechanism.

In one example, the generic feature extraction sub-model is a visual base model based on the attention mechanism.

In one example, the generic feature extraction sub-model is trained based on images of industrial components in a plurality of domains, wherein the plurality of domains correspond to a plurality of industrial component types or correspond to a plurality of industrial component production lines, respectively.

In one example, the first domain is one domain in the plurality of domains. In one example, the first domain is one domain other than the plurality of domains. The task inspection sub-model is trained based on the image of the industrial component in the first domain. In one example, the first domain image used to train the task inspection sub-model is different or not identical to the first domain image used to train the generic feature extraction sub-model.

In one example, the method 900 further comprises obtaining a second image of a second inspected component of a second domain, the second domain corresponding to a second industrial component type or corresponding to a second industrial component production line; inputting the second image of the second inspected component into the inspection model, the inspection model further comprising at least one second task inspection sub-model associated with a particular AOI task of the second domain; generating, by the generic feature extraction sub-model, a first feature representation of the second image based on the second image of the second inspected component; and generating, by the at least one second task inspection sub-model, at least one inspection result associated with the particular AOI task of the second domain based on the first feature representation of the second image.

FIG. 10 shows a flow chart of a method of training an inspection model for AOI according to one example.

At step 1010, images of the industrial components in a plurality of domains are collected as a multi-domain AOI training dataset, wherein the plurality of domains correspond to a plurality of industrial component types or correspond to a plurality of industrial component production lines, respectively.

At step 1020, the generic feature extraction sub-model in the inspection model is pre-trained based on the multi-domain AOI training dataset to obtain the trained generic feature extraction sub-model.

At step 1030, at least one task inspection sub-model associated with the particular AOI task of the first domain in the inspection model is trained based on the image of the industrial component in the first domain as a single-domain AOI training dataset, the first domain corresponds to a first industrial component type or corresponds to a first industrial component production line, wherein the trained generic feature extraction sub-model receives an image in the single-domain AOI training dataset and outputs a first feature representation of the image, and the at least one task inspection sub-model receives the first feature representation of the image and predicts at least one inspection result associated with the particular AOI task of the first domain.

In one example, at step 1020, data enhancement is performed on the multi-domain AOI training dataset without a label to obtain a multi-domain AOI training image pair set, and the generic feature extraction sub-model is trained using a comparative learning method based on the multi-domain AOI training image pair set; and/or training the generic feature extraction sub-model using the MAE method based on the multi-domain AOI training dataset without the label.

In one example, at step 1020, training the generic feature extraction sub-model using the comparative learning method based on the multi-domain AOI training image pair set comprises: receiving, by the generic feature extraction sub-model, an image pair in the multi-domain AOI training image pair set and outputting a first feature representation of the image pair, obtaining a similarity of the image pair by a comparative learning module based on the first feature representation of the image pair, obtaining a comparative learning loss based on the similarity of the image pair, and updating the generic feature extraction sub-model based on the comparative learning loss; and/or training the generic feature extraction sub-model using the MAE method comprises: randomly masking an original image in the multi-domain AOI training dataset to obtain a masked image, receiving, by the generic feature extraction sub-model, the masked image and outputting a first feature representation of the masked image, predicting a restored image by a decoder module based on the first feature representation of the masked image, obtaining an MAE loss based on the restored image and the original image, and updating the generic feature extraction sub-model based on the MAE loss.

In one example, at step 1030, the task inspection sub-model is trained based on the single-domain AOI training dataset with a label.

In one example, the method 1000 further comprises: training at least one second task inspection sub-model associated with a second particular AOI task of the second domain in the inspection model based on an image of an industrial component in a second region as a second single-domain AOI training dataset, the second domain corresponding to a second industrial component type or corresponding to a second industrial component production line, wherein the trained generic feature extraction sub-model receives a second image in the second single-domain AOI training dataset and outputs a first feature representation of the second image, and the at least one second task inspection sub-model receives the first feature representation of the second image and predicts at least one inspection result associated with the second particular AOI task of the second domain.

FIG. 11 shows a block diagram of a device for AOI of an industrial component according to one example. The device 1100 comprises: an image obtaining module 1110 for obtaining an image of an inspected component of a first domain, the first domain corresponding to a first industrial component type or corresponding to a first industrial component production line; an inspection module 1120, the inspection module comprising a generic feature extraction sub-module and at least one task inspection sub-module associated with a particular AOI task of the first domain, the generic feature extraction sub-module generating a first feature representation of the image based on the image of the inspected component, and the at least one task inspection sub-module generating at least one inspection result associated with the particular AOI task of the first domain based on the first feature representation of the image.

In one example, the image obtaining module 1110 obtains a second image of a second inspected component of a second domain, the second domain corresponding to a second industrial component type or corresponding to a second industrial component production line, wherein the inspection module 1120 further comprises at least one second task inspection sub-module associated with a particular AOI task of the second domain, wherein the generic feature extraction sub-module generates a first feature representation of the second image based on the second image of the second inspected component, and the at least one second task inspection sub-module generates at least one inspection result associated with the particular AOI task of the second domain based on the first feature representation of the second image.

In one example, the inspection module 1120 shown in FIG. 11 may be the inspection model 1210 described above in connection with FIG. 1, FIG. 3, FIG. 4, FIG. 5 wherein the generic feature extraction sub-module and the task inspection sub-module may be the visual base model 310 and the task inspection model 320 described above in connection with FIG. 3, FIG. 4, FIG. 5.

FIG. 12 shows a block diagram of a processing system of AOI for an industrial component according to one example. The control system or processing system 1200 may comprise one or more control units or processing units 1210, and the control units 1210 execute one or more machine-readable instructions stored or encoded in a machine-readable storage medium (i.e., memory 1220). Although not shown in FIG. 12, those skilled in the art may appreciate that the control system 1200 may comprise various other components, for example, various communication modules, bus modules, and possible user interface modules, and the like. In one example, the processing unit 1210, when executing the program instructions, is configured to perform various operations and functions described above in connection with FIG. 1 to FIG. 11.

According to one example, a program product, such as a non-transitory machine-readable medium, is provided. The non-transitory machine-readable medium may have instructions that, when executed by the processing unit 1210, are capable of performing various operations and functions described above in connection with FIG. 1 to FIG. 11 in various examples of the present application.

Exemplary examples are described above with reference to the specific examples described in the accompanying drawings, but do not represent all examples that may be implemented or fall within the scope of protection of the claims. Throughout the present Specification, the term “exemplary” means “serving as an example, instance, or illustration” and does not imply “preferred” or “advantageous” over other examples. Specific examples comprise specific details to facilitate understanding of the described technology. However, these technologies may be implemented without these specific details. In some instances, to avoid causing difficulties in understanding the concepts of the described examples, known structures and devices are shown in block diagram form.

The aforementioned description of the present application is provided to allow any person of ordinary skill in the art to implement or use the present application. Various modifications to the present application will be apparent to those of ordinary skill in the art, and the general principles defined herein may be applied to other variations without departing from the scope of protection of the present application. Therefore, the present application is not limited to the exemplary examples and designs described herein but is consistent with the broadest scope defined by the principles and novel features disclosed herein.

What is claimed is:

1. A method for automatic optical inspection (AOI), comprising:
obtaining an image of an inspected component of a first domain, the first domain corresponding to a first industrial component type or corresponding to a first industrial component production line;
inputting the image of the inspected component into an inspection model, the inspection model comprising a generic feature extraction sub-model and at least one task inspection sub-model associated with a particular AOI task of the first domain;
generating, by the generic feature extraction sub-model, a first feature representation of the image based on the image of the inspected component; and
generating, by the at least one task inspection sub-model, at least one inspection result associated with the particular AOI task of the first domain based on the first feature representation of the image.

2. The method of claim 1, wherein the particular AOI task of the first domain comprises at least one or at least two of the following tasks:
a classification task for classifying the image of the inspected component into one class of a plurality of classes; a segmentation task for segmenting a defective area in the image of the inspected component; and an identification task for identifying the defective area in the image of the inspected component.

3. The method of claim 2, wherein when the particular AOI task of the first domain is the classification task, the task inspection sub-model is a multi-layer perceivorator (MLP) model;
when the particular AOI task of the first domain is the segmentation task, the task inspection sub-model is a mask decoder of a convolutional neural network (CNN) model or a decoder based on an attention mechanism; and
when the particular AOI task of the first domain is the identification task, the task inspection sub-model is a boundary frame decoder with a classification result of the CNN model or the decoder based on the attention mechanism.

4. The method of claim 1, wherein the generic feature extraction sub-model is a visual base model based on an attention mechanism.

5. The method of claim 4, wherein the generic feature extraction sub-model is trained based on images of industrial components in a plurality of domains, and wherein the plurality of domains correspond to a plurality of industrial component types, respectively or correspond to a plurality of industrial component production lines, respectively.

6. The method of claim 5, wherein the first domain is one domain in the plurality of domains, or the first domain is one domain other than the plurality of domains, and wherein the task inspection sub-model is trained based on an image of an industrial component in the first domain.

7. The method of claim 1, further comprising:
obtaining a second image of a second inspected component of a second domain, the second domain corresponding to a second industrial component type or corresponding to a second industrial component production line;
inputting the second image of the second inspected component into the inspection model, the inspection model further comprising at least one second task inspection sub-model associated with a particular AOI task of the second domain;
generating, by the generic feature extraction sub-model, a first feature representation of the second image based on the second image of the second inspected component; and
generating, by the at least one second task inspection sub-model, at least one inspection result associated with the particular AOI task of the second domain based on the first feature representation of the second image.

8. A method of training an inspection model for automatic optical inspection (AOI), comprising:
collecting images of industrial components in a plurality of domains as a multi-domain AOI training dataset, wherein the plurality of domains correspond to a plurality of industrial component types, respectively or correspond to a plurality of industrial component production lines, respectively;
training the generic feature extraction sub-model in the inspection model based on the multi-domain AOI training dataset to obtain a trained generic feature extraction sub-model;
training at least one task inspection sub-model associated with a particular AOI task of a first domain in the inspection model based on an image of an industrial component in the first domain as a single-domain AOI training dataset, the first domain corresponding to a first industrial component type or corresponding to a first industrial component production line, wherein the trained generic feature extraction sub-model receives an image in the single-domain AOI training dataset and outputs a first feature representation of the image, and the at least one task inspection sub-model receives the first feature representation of the image and predicts at least one inspection result associated with the particular AOI task of the first domain.

9. The method of claim 8, wherein training the generic feature extraction sub-model in the inspection model based on the multi-domain AOI training dataset comprises:
performing data enhancement on the multi-domain AOI training dataset without a label to obtain a multi-domain AOI training image pair set, and training the generic feature extraction sub-model using a comparative learning method based on the multi-domain AOI training image pair set; and/or
training the generic feature extraction sub-model using a masked autoencoder (MAE) method based on the multi-domain AOI training dataset without the label.

10. The method of claim 9, wherein:
training the generic feature extraction sub-model using the comparative learning method based on the multi-domain AOI training image pair set comprises: receiving, by the generic feature extraction sub-model, an image pair in the multi-domain AOI training image pair set and outputting a first feature representation of the image pair, obtaining a similarity of the image pair by a comparative learning module based on the first feature representation of the image pair, obtaining a comparative learning loss based on the similarity of the image pair, and updating the generic feature extraction sub-model based on the comparative learning loss; and/or
training the generic feature extraction sub-model using the MAE method comprises: masking an original image in the multi-domain AOI training dataset to obtain a masked image, receiving, by the generic feature extraction sub-model, the masked image and outputting a first feature representation of the masked image, predicting, by a decoder module, a restored image based on the first feature representation of the masked image, obtaining an MAE loss based on the restored image and the original image, and updating the generic feature extraction sub-model based on the MAE loss.

11. The method of claim 8, wherein training at least one task inspection sub-model associated with the particular AOI task of the first domain in the inspection model based on the image of the industrial component in the first domain as the single-domain AOI training dataset comprises: training the task inspection sub-model based on the single-domain AOI training dataset with a label.

12. The method of claim 8, further comprising:
training at least one second task inspection sub-model associated with a second particular AOI task of a second domain in the inspection model based on an image of an industrial component in the second region as a second single-domain AOI training dataset, the second domain corresponding to a second industrial component type or corresponding to a second industrial component production line, wherein the trained generic feature extraction sub-model receives a second image in the second single-domain AOI training dataset and outputs a first feature representation of the second image, and the at least one second task inspection sub-model receives the first feature representation of the second image and predicts at least one inspection result associated with the second particular AOI task of the second domain.

13. A device for automatic optical inspection (AOI), comprising:
an image obtaining module configured to obtain an image of an inspected component of a first domain, the first domain corresponding to a first industrial component type or corresponding to a first industrial component production line;
an inspection module, the inspection module comprising a generic feature extraction sub-module and at least one task inspection sub-module associated with a particular AOI task of the first domain, the generic feature extraction sub-module configured to generate a first feature representation of the image based on the image of the inspected component, and the at least one task inspection sub-module configured to generate at least one inspection result associated with the particular AOI task of the first domain based on the first feature representation of the image.

14. The device of claim 13, wherein the image obtaining module is configured to obtain a second image of a second inspected component of a second domain, the second domain corresponding to a second industrial component type or corresponding to a second industrial component production line,
wherein the inspection module further comprises at least one second task inspection sub-module associated with a particular AOI task of the second domain, wherein the generic feature extraction sub-module is configured to generate a first feature representation of the second image based on the second image of the second inspected component, and the at least one second task inspection sub-module is configured to generate at least one inspection result associated with the particular AOI task of the second domain based on the first feature representation of the second image.

15. A system for automatic optical inspection (AOI), comprising:
an image capture apparatus configured to capture an image of an inspected component;
one or more processors; and
one or more memories, the memories having computer-executable instructions stored thereon, and the instructions, when run by the one or more processors, perform the operations of claim 1.

16. A computer system, comprising:
one or more processors; and
one or more memories, the memories having computer-executable instructions stored thereon, and the instructions, when run by the one or more processors, perform the operations of claim 1.

17. A machine-readable storage medium having executable instructions stored thereon, the instructions, when executed, cause one or more processors to perform the method of claim 1.
